(19) United States
(12) Patent Application Publication
(10) Pub. No.: US 2005/0153079 A1
(43) Pub. Date: Jul. 14, 2005

(54) Method of manufacturing laminated polarizing plate, laminated polarizing plate obtained by the method, and image display including the same

(75) Inventors: Yoshihiro Hieda, Ibaraki-shi (JP); Yuuzou Akada, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Ibaraki-shi (JP)

(21) Appl. No.: 11/017,874

(22) Filed: Dec. 22, 2004

(30) Foreign Application Priority Data
Dec. 25, 2003 (JP) 2003-431173

(51) Int. Cl. B32B 1/00; C09K 19/00

(52) U.S. Cl. 428/1.2; 428/333; 428/1.3

(57) ABSTRACT

The present invention provides a method of manufacturing a laminated polarizing plate that can prevent projections and swellings from being produced at cutting planes in manufacturing the laminated polarizing plate that is excellent in self-standing ability. A polarizing plate and a resin film are laminated together and then this laminate is cut with a dicer. Thus a laminated polarizing plate is manufactured. A film having a light transmittance of at least 80% and a glass-transition temperature of at least 100° C. is used for the resin film. For instance, an epoxy resin film is preferable as the resin film.

### BACKGROUND OF THE INVENTION

1. Field of the Invention

The present invention relates generally to a method of manufacturing a laminated polarizing plate, a laminated polarizing plate obtained by the method, and an image display including the same used therein.

2. Related Background Art

In a liquid crystal display, a polarizing plate generally is attached to each face of a liquid crystal cell. However, when a liquid crystal cell with polarizing plates attached thereto in such a manner is used for a viewfinder of, for instance, a video camera, a digital camera, a projector, etc., the following problems arise.

Viewfinders, projectors, etc. have a configuration in which a liquid crystal cell is irradiated with a light source from its back face and an image illuminated thereby is magnified and projected through a magnifying lens system disposed in front of the liquid crystal cell. Accordingly, the focal point of the magnifying lens generally is adjusted to be on a color filter disposed inside the liquid crystal cell. Polarizing plates, however, are in close contact with the liquid crystal cell and as a result, the polarizing plates also may be located within the depth of focus of the magnifying lens system in many cases. In this case, if foreign matters such as dusts have stuck on the polarizing plates, the foreign matters also are located within the depth of focus of the magnifying lens system. Accordingly, the contours of the foreign matters also are projected and thereby the display quality deteriorates remarkably. Particularly, since the polarizing plates generally are produced by attaching a polarizing film and a transparent protective layer to each other, there is a possibility that foreign matters may be introduced into the polarizing plates in producing them, or foreign matters may be introduced into the interfaces between the liquid crystal cell and the polarizing plates in attaching the polarizing plates to the liquid crystal cell.

Recently, in order to solve such problems, a new method has been disclosed in which polarizing plates are disposed outside a liquid crystal cell at a sufficient distance therefrom (see, for instance, JP6(1994)-258637A; Patent Document 1). In the case where the polarizing plates are disposed well apart from the liquid crystal cell as described in Patent Document 1, even when the focal point of a magnifying lens system is set to be on the liquid crystal cell, the focal point does not fall on the polarizing plates. Hence, even when foreign matters are introduced into the polarizing plates in producing them, the foreign matters are not located within the depth of focus. Thus, it is possible to prevent the display quality from being adversely affected.

However, when the configuration described in Patent Document 1 mentioned above is employed, the following problems arise. That is, since the polarizing plates have poor rigidity and no self-standing ability, it is difficult to dispose the polarizing plates by themselves at a sufficient distance from the liquid crystal cell. Accordingly, it is necessary to put a cover member outside the liquid crystal cell substrate additionally and then to attach the polarizing plates onto the cover member. Such a configuration, however, requires complicated processes for producing a liquid crystal display. This causes problems such as increases in size and cost, a reduction in screen size, etc. Such problems arise not only in liquid crystal displays but also in other displays.

### SUMMARY OF THE INVENTION

Hence, the present invention is intended to provide: a manufacturing method that makes it possible to manufacture a laminated polarizing plate that can be disposed even by itself at a certain distance from a display device such as a liquid crystal cell; a laminated polarizing plate obtained by the method; and an image display including the same.

In order to achieve the above-mentioned objects, the manufacturing method of the present invention is a method of manufacturing a laminated polarizing plate that includes: a laminating process in which a polarizing plate film and a resin film are laminated together to form a lamination film, with the resin film having a light transmittance of at least 80% and a glass-transition temperature of at least 100° C.; and a cutting process using a dicer in which the lamination film is cut with a dicer to be divided into laminated polarizing plates.

The laminated polarizing plate of the present invention is a laminated polarizing plate formed of a polarizing plate and a resin film that are laminated together, wherein the laminated polarizing plate is obtained by the manufacturing method of the present invention.

Furthermore, the image display of the present invention is an image display including an image display element and a polarizing plate, wherein the polarizing plate is a laminated polarizing plate of the present invention, and the laminated polarizing plate is disposed at a certain distance from the image display element.

In order to achieve the above-mentioned objects, the present inventors first made a series of studies on the self-standing ability of polarizing plates. As a result, it was found that when a polarizing plate film was laminated with a resin film having a light transmittance of at least 80% and a glass-transition temperature of at least 100° C., the rigidity of the polarizing plate was improved with its transparency being maintained, and as a result, it was possible to provide the polarizing plate film with self-standing ability. It is necessary to cut the lamination film into various shapes and sizes according to uses of the polarizing plates to be obtained thereby. However, when a conventional cutting method is used for cutting the lamination film, a problem arises with respect to cutting planes. That is, since laser irradiation mainly is employed in the conventional method of cutting polarizing plates, when being cut with a laser, the polarizing plates deteriorate due to the heat of the laser and projections like fine splits are produced on the cutting planes or the cutting planes swell. The projections are difficult to remove even when the cutting planes are washed. Furthermore, when the polarizing plate having such projections or swellings produced at its cutting planes are attached to the body of a product, the projections may be introduced into the body or the swellings may cause an attachment failure. This problem also arises in the lamination film of the present invention. Hence, in order to solve this problem, the present inventors made further studies while focusing on the cutting method. As a result, they found that when the lamination film was cut with a dicer, it was possible to prevent the projections and swellings described above from being produced. In this case, when a conventional polarizing plate is cut by the dicing method, projections and swellings still are produced at the cutting planes thereof. However, when the lamination film is cut using a dicer, no projections or swellings are produced although the reason is unclear. As described above, the manufacturing method of the present invention can prevent projections and swellings from being produced at cutting planes. Accordingly, the laminated polarizing plate of the present invention obtained by the manufacturing method make it possible to avoid problems such as the introduction of projections or the attachment failure when the laminated polarizing plate is attached to the body of a product. Moreover, since the laminated polarizing plate obtained by the manufacturing method of the present invention has excellent self-standing ability, it can be disposed by itself at a certain distance from a liquid crystal cell in a liquid crystal display to be used for a projector or a viewfinder of a digital camera, for example. Furthermore, effects to be obtained through the employment of the dicing in the present invention include the followings. That is, while the laser irradiation causes gas generation, the dicing prevents gas generation and thereby makes it possible to lower the level of washing to be carried out in a later process. In this context, the cutting to be carried out by the dicing method (i.e. the dicing) denotes a method of cutting that is carried out while generally a blade including grains of, for instance, diamond in a metal or resin plane is rotated at high speed. There are a wet dicing method in which a liquid, such as water is used and a dry dicing method in which no water is used.

### BRIEF DESCRIPTION OF THE DRAWINGS

FIG. 1 is a plan view showing an example of the laminated polarizing plate according to the present invention.

FIG. 2 is a cross-sectional view showing an example of the liquid crystal display according to the present invention.

### DETAILED DESCRIPTION OF THE INVENTION

The manufacturing method of the present invention is described below using examples. The manufacturing method of the present invention includes: a laminating process in which a polarizing plate film and a resin film are laminated together to form a lamination film, with the resin film having a light transmittance of at least 80% and a glass-transition temperature of at least 100° C.; and a dicing process in which the lamination film is cut with a dicer to be divided into laminated polarizing plates. With respect to the resin film, the light transmittance is preferably in the range of 80% to 100%, more preferably 85% to 100%, while the glass-transition temperature is preferably in the range of 100° C. to 400° C., more preferably 150° C. to 400° C.

The polarizing plate film is not particularly limited. The conventionally well-known polarizing plates described later can be used for the polarizing plate film. On the other hand, the resin film is not particularly limited as long as it has a light transmittance of at least 80% and a glass-transition temperature of at least 100° C. However, a resin film that is excellent in transparency, impact resistance, and heat resistance is preferable. Specific examples thereof are described later. The glass-transition temperature can be determined, for example, from the peak value of tanδ obtained from the result of measurements of viscoelasticity in the range of −30° C. to 200° C. using a visco-elastometer ARES manufactured by TA INSTRUMENTS JAPAN.

The thickness of the resin film is not particularly limited but is preferably in the range of, for instance, 0.05 mm to 1.5 mm.

The method of laminating the polarizing plate film and the resin film together is not particularly limited and the lamination can be carried out by a conventionally well-known method. Furthermore, when the lamination is carried out with an adhesive or a pressure-sensitive adhesive, the type thereof is not limited and those described later can be used.

Next, the description is made with respect to the cutting (dicing) to be carried out by the dicing method. The dicing apparatus to be used for the dicing is not particularly limited. Examples of the dicing apparatus to be used herein include dicing apparatuses (dicers) for cutting semiconductor wafers, various types of glass, plastics, semiconductor packages, substrate materials, etc. As described before, there are a dicing apparatus of a wet type in which water is used and a dicing apparatus of a dry type in which no water is used, both of which can be used herein. Furthermore, there are a single dicer and a dicer such as a dual dicer in which a plurality of blades can be attached, both of which can be used. The method of attaching the laminate to the dicing apparatus is not particularly limited. Examples of the method include a method of attaching it with both a pressure-sensitive adhesive tape and a dicing ring and a method of attaching it to a special-purpose fixture through adsorption. The pressure-sensitive adhesive tape can be of a common pressure-sensitive type or a radiation curable type, for example. A particularly preferable adhesive tape is one whose adhesiveness is high before dicing but can decrease considerably after dicing due to radiation exposure. The thickness of the pressure-sensitive adhesive tape is not particularly limited. It is, for instance, in the range of 30 μm to 1000 μm but is preferably in the range of 100 μm to 300 μm in consideration of, for instance, securing the depth to which the tape is cut in, which is described later.

The dicing blade to be attached to the dicing apparatus is not particularly limited and those used for cutting, for instance, semiconductor wafers, various types of glass, plastics, semiconductor packages, or substrates can be used. The thickness of the dicing blade is not particularly limited. It is, for instance, in the range of 30 μm to 1000 μm but is preferably in the range of 30 μm to 500 μm, and more preferably in the range of 80 μm to 300 μm in consideration of, for instance, cutting stability and cutting efficiency. The grit size of the dicing blade is not particularly limited but is, for instance, in the range of #200 to #1000 in consideration of its lifetime, smoothness of cutting planes, clogged-up tendency, etc. The rotating speed of the dicing blade during dicing is, for instance, in the range of 10000 rpm to 60000 rpm but is preferably in the range of 30000 rpm to 60000 rpm in consideration of unevenness to be caused at cutting planes, cutting speed, etc. Moreover, the rotating direction also is not particularly limited. A so-called up-mode or down-mode, or a combination thereof can be employed without causing any problem.

The dicing speed is, for instance in the range of 10 to 300 mm/sec but is preferably in the range of 50 to 200 mm/sec in consideration of cutting efficiency and stability of cutting planes.

In the case of using the aforementioned wet dicer, cutting is carried out, with water being poured for cooling and washing during dicing. The amount of water to be used for dicing is adjusted optimally according to the apparatus and conditions to be employed.

In the case of using the pressure-sensitive adhesive tape, it is preferable that the dicing blade cut into the tape. The depth to which the blade cuts into the tape is, for instance, in the range of more than 0 μm but not more than 200 μm, but is preferably in the range of 30 μm to 120 μm in consideration of stability in cutting quality, etc.

In order to cut one line in dicing, cutting generally is carried out once. However, it can be carried out a plurality of times, which provides advantages that cutting planes have higher smoothness or cuttings produced at the line thus cut can be removed. In this case, the use of a dual dicer allows cutting to be carried out more efficiently. The depth of the first cutting and the depth of the second cutting can be determined arbitrarily. The laminate can be cut completely by the first cutting and the second cutting can be carried out on the same line as that cut by the first cutting to clean it. Alternatively, the cutting depths to be employed for the first cutting and the second cutting can be varied to reduce the load to be imposed during cutting. In addition, the cutting order also can be determined arbitrarily. Moreover, it also is possible to change the cutting speed and cutting direction on one line.

The shape and size of a laminated polarizing plate cut from the laminate are not particularly limited. For instance, they may be determined according to the shape and size of an image display in which the laminated polarizing plate is to be used. The cutting shape is, for instance, quadrangle. The laminate may be cut in the absorption axis direction and the vertical axis direction (or the direction perpendicular to the polarization axis) in the polarizing plate of the lamination film. For instance, in the case of a laminated polarizing plate to be employed for a liquid crystal display to be used for a viewfinder of a video camera or a digital camera, at least 200 laminated polarizing plates with a size of 10 mm×11 mm can be obtained from a quadrangular lamination film with a size of 200 mm×200 mm.

Preferably, after the laminate is cut, the laminated polarizing plates obtained thereby are subjected to a washing treatment as required. The type of the washing treatment is not particularly limited. In the case of a wet type of washing treatment, it may be carried out by, for instance, washing with liquid such as water, air wash (air blow) by blowing air, or the combination thereof In order to remove superfluous water, air blow may be carried out additionally.

As described before, when a plurality of laminated polarizing plates have been formed by dicing to be carried out on a dicing base such as, for instance, a pressure-sensitive adhesive tape, a surface protective sheet may be attached to the other surfaces (the surfaces located on the opposite side to the dicing base side) of the plurality of laminated polarizing plates, with a pressure-sensitive adhesive being interposed therebetween. Furthermore, after the attachment of such a surface protective sheet, the dicing base attached to the surfaces of the laminated polarizing plates on the opposite side to the side where the surface protective sheet has been attached may be removed and then a surface protective sheet may be attached thereto instead.

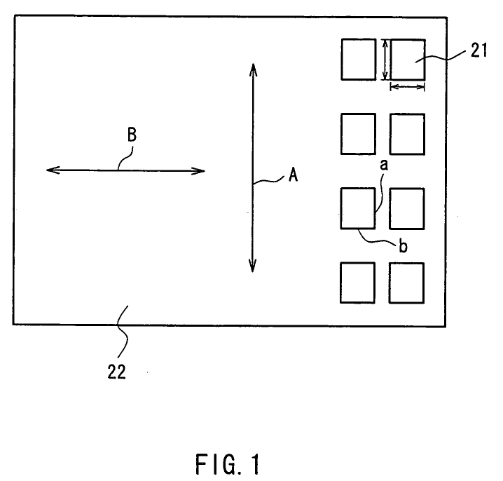

FIG. 1 shows a plan view of an example in which a plurality of laminated polarizing plates of the present invention that have been cut into quadrangles are placed on a surface protective sheet. In FIG. 1, double-headed arrows A and B indicate a polarization axis of the polarizing plates and an absorption axis that is orthogonal thereto while a and h denote cutting planes of the laminated polarizing plates 21. As shown in FIG. 1, the plurality of laminated polarizing plates 21 cut out in the polarization axis direction and the absorption axis direction are arranged at equal intervals on the surface protective sheet 22. In the present invention, the interval (pitch) at which the laminated polarizing plates are aligned is not particularly limited.

In the manufacturing method of the present invention, the polarizing plate film can be a conventionally well-known polarizing plate film. Generally, a polarizing plate film can be used in which a transparent protective layer is provided for one face or both faces of a polarizer (a polarizing film). The polarizer is not particularly limited. Conventionally well-known polarizing films can be used. Specifically, for instance, polarizing films can be used that are prepared by a method in which various films are dyed through adsorption of dichronic substance such as iodine or a dichronic dye and then are crosslinked, drawn, and dried. Among them, films that transmit linearly polarized light when natural light is incident thereon are preferable, and films that are excellent in light transmittance and polarization degree are preferable. Examples of the various films that are allowed to adsorb the dichronic substance include hydrophilic polymer films such as a PVA film, a partially formalized PVA film, a partially saponified film of ethylene-vinyl acetate copolymer, a cellulose film, etc. In addition, for instance, polyene alignment films of dehydrated PVA, dehydrochlorinated poly(vinyl chloride), etc. also can be used. Among them, a PVA film is preferable. The thickness of the polarizing film is, for instance, in the range of 5 μm to 80 μm but is not limited thereto.

The transparent protective layer is not particularly limited, and conventionally well-known transparent films can be used. For instance, films that are excellent in transparency, mechanical strength, heat stability, water-shielding property, isotropism, etc. are preferable. Specific examples of the materials for such transparent protective layers include: polyester polymers such as polyethyleneterephthalate, polyethylenenaphthalate, etc.; cellulose polymers such as diacetyl cellulose, triacetyl cellulose, etc.; acrylic polymers such as polymethyl acrylate, polymethyl methacrylate, etc.; styrene polymers such as polystyrene, acrylonitrile-styrene copolymer (AS resin), etc.; and polycarbonate polymers. In addition, other examples of the materials include: polyolefin polymers such as polyethylene, polypropylene, polyolefin having a cyclo or norbornene structure, ethylene-propylene copolymer, etc.; vinyl chloride polymers; nylon and aromatic polyamide polymers; imide polymers; sulfone polymers; polyethersulfone polymers; polyetherether ketone polymers; vinylidene chloride polymers; vinyl alcohol polymers; vinyl butyral polymers; allylate polymers; polyoxymethylene polymers; epoxy polymers; and blends thereof Among them, cellulose polymers such as triacetyl cellulose are preferable. The thickness of the transparent protective film is not particularly limited but generally is 500 μm or less, preferably 1 μm to 300 μm, and more preferably 5 μm to 200 μm.

The polarizer and the transparent protective layer are laminated together, for instance, using an adhesive to form one body. Examples of the adhesive to be used herein include isocyanate adhesives, poly(vinyl alcohol) adhesives, gelatin adhesives, vinyl latex adhesives, aqueous polyesters adhesives, etc.

The surface of the polarizing plate film may be subjected to various treatments such as, for instance, a hard-coat treatment, an antireflection treatment, a treatment for sticking prevention, a diffusion treatment, an anti-glare treatment, an anti-glare treatment that also serves as an antireflection treatment, an antistatic treatment, a treatment for contamination control, etc. according to the purpose of its use.

The hard-coat treatment is intended to prevent the surface of the polarizing plate film from being damaged. It can be carried out by, for instance, a method in which a curable film that is excellent in hardness and slide property is formed on the surface of the polarizing plate film using an ultraviolet curable resin such as an acrylic resin, a silicone resin, etc. The antireflection treatment is intended to prevent external light from being reflected by an optical film surface. It can be implemented through the formation of, for instance, a conventionally well-known antireflection film (a physical-optical thin film or a coating thin film).

The anti-glare treatment is intended to prevent visibility of light transmitted through the polarizing plate from being inhibited due to external light reflected by an optical film surface. The anti-glare treatment may be carried out by, for instance, roughening the film surface by a sandblasting method, an embossing method, etc. or providing the film surface with a minute concavo-convex structure by, for example, a film forming method in which transparent particles are blended into a film forming material. The particles to be used in forming minute concavities and convexities at the surface can be transparent particles that have a mean particle diameter of, for instance, 0.5 μm to 50 μm and that are formed of inorganic materials such as silica, alumina, titania, zirconia, tin oxides, indium oxides, cadmium oxides, antimony oxides, etc. When the minute concavo-convex structure is formed at the surface, the amount of particles to be used is generally about 2 to 50 weight parts, preferably 5 to 25 weight parts, with respect to 100 weight parts of resin. The anti-glare layer also may serve as a diffusion layer (for instance, a function of compensating a viewing angle) for diffusing light transmitted through the polarizing plate and thereby compensating the viewing angle, etc.

Preferable resin films that can be used in the manufacturing method of the present invention are resin films that are excellent in transparency, impact resistance, and heat resistance as described before. Examples of the resin films include those formed of an epoxy resin, a polyester resin, an acrylic resin, a methacrylic resin, a polycarbonate (PC) resin, a polyethylenenaphthalate (PEN) resin, a polyethyleneterephthalate (PET) resin, a triacetylcellulose (TAC) resin, a polynorbornene resin (for instance, Product Name: ARTON Resin, manufactured by JSR Corporation), a polyimide resin, a polyetherimide resin, a polyamide resin, a polysulfone resin, a polyphenylene sulfide resin, a polyethersulfone resin, etc. These resins can be used individually to produce the resin film, or two or more of the resins can be used together to produce the resin film. Among them, an acrylic resin or an epoxy resin is preferable.

Preferably, the epoxy resin has an epoxy equivalent of 100 to 1000 and a softening point of 120° C. or lower in consideration of physical properties such as flexibility, strength, etc. of a resin film to be obtained. Furthermore, it is preferable that, for instance, a two-liquid mixture type that is in a liquid state at a temperature employed in coating, particularly at ordinary temperature, be used from the viewpoint of, for instance, obtaining a solution containing an epoxy resin that is excellent in coatability, ability of being spread into a film shape, etc.

Examples of the epoxy resin include: bisphenol types such as a bisphenol A type, a bisphenol F type, a bisphenol S type, and hydrogenated forms thereof, novolak types such as a phenolic novolak type, a cresol novolak type, etc.; nitrogen-containing cyclic types such as a triglycidyl isocyanurate type, a hydantoin type, etc.; alicyclic types; aliphatic types; aromatic types such as a naphthalene type, etc.; low-water-absorption types such as a glycidyl ether type, a biphenyl type, etc.; dicyclo types; ester types; etherester types; and modified types thereof. These resins may be used individually or two or more of them may be used together. Among them, an epoxy resin of bisphenol A type, an alicyclic epoxy resin, and an epoxy resin of triglycidyl isocyanurate type are preferable, and an alicyclic epoxy resin is particularly preferable, in view of, for instance, discoloration inhibition ability.

Furthermore, since the epoxy resin is excellent in optical isotropy, it is preferable that the retardation thereof be 5 nm or less, particularly 1 nm. Preferably, the resins other than the epoxy resin also are excellent in optical isotropy. Specifically, it is preferable that the retardation thereof be 5 nm or less, particularly 1 nm or less.

Conventionally well-known various additives may be blended suitably into the epoxy resin. The conventionally well-known various additives include, for example, a curing agent, a curing accelerator, and agents, which conventionally are used as required, that include an antioxidant, a modifier, a surfactant, a dye, a pigment, a discoloration inhibitor, an ultraviolet absorber, etc. For instance, when an acid anhydride curing agent and a phosphorus curing catalyst are blended into an epoxy resin such as an epoxy resin of bisphenol A type, an alicyclic epoxy resin, a triglycidyl isocyanurate epoxy resin, etc, the epoxy resin can be cured thereby.

The curing agent is not particularly limited and is determined suitably according to the type of the epoxy resin to be used. Examples of the curing agent include: organic acid compounds such as tetrahydrophthalic acid, methyltetrahydrophthalic acid, hexahydrophthalic acid, methylhexahydrophthalic acid, etc.; amine compounds such as ethylenediamine, propylenediamine, diethylenetriamine, triethylenetetramine, amine adducts thereof, metaphenylenediamine, diaminodiphenylmethane, diaminodiphenylsulfone, etc.; amide compounds such as dicyandiamide, polyamide, etc.; hydrazide compounds such as dihydrazide, etc.; imidazole compounds such as methylimidazole, 2-ethyl-4-methylimidazole, ethylimidazole, isopropylimidazole, 2,4-dimethylimidazole, phenylimidazole, undecylimidazole, heptadecylimidazole, 2-phenyl-4-methylimidazole, etc.; imidazoline compounds such as methylimidazoline, 2-ethyl-4-methylimidazoline, ethylimidazoline, isopropylimidazoline, 2,4-dimethylimidazoline, phenylimidazoline, undecylimidazoline, heptadecylimidazoline, 2-phenyl-4-methylimidazoline, etc.; phenol compounds; urea compounds; polysulfide compounds; and acid anhydride compounds. These curing agents may be used individually or two or more of them may be used together. Among them, acid anhydride compounds are used preferably since they are excellent in discoloration inhibition.

Examples of the acid anhydride compounds include phthalic anhydride, maleic anhydride, trimellitic anhydride, pyromellitic anhydride, nadic anhydride, glutaric anhydride, tetrahydrophthalic anhydride, methyltetrahydrophthalic anhydride, hexahydrophthalic anhydride, methylhexahydrophthalic anhydride, methylnadic anhydride, dodecenylsuccinic anhydride, dilchlorosuccinic anhydride, benzophenonetetracarboxylic anhydride, chlorendic anhydride, and trihydroxyethylisocyanuric anhydride. Among them, acid anhydride compounds that are colorless to pale yellow and have a molecular weight of about 140 to about 200 are preferable. Specific examples thereof include trihydroxyethylisocyanurate-modified phthalic anhydride, tetrahydrophthalic anhydride, hexahydrophthalic anhydride, and methylhexahydrophthalic anhydride.

With respect to the blending ratio between the epoxy resin and the curing agent, when, for instance, an acid anhydride curing agent is used as the curing agent, it is preferable that they be blended so that the amount of the acid anhydride is 0.5 to 1.5 equivalents, more preferably 0.7 to 1.2 equivalents, per equivalent of epoxy groups of the epoxy resin. Such ranges allow the resin film to exhibit better hue and moisture resistance after curing. Similarly, when another curing agent is used alone or two or more of other curing agents are used together, the blending ratio thereof is determined according to the equivalent ratio described above.

Examples of the curing accelerator include tertiary amines, imidazoles, quaternary ammonium salts, organometallic salts, phosphorus compounds, and urea compounds. They may be used individually or two or more of them may be used together. Among them, tertiary amines, imidazoles, and phosphorus compounds are particularly preferable.

With respect to the blending ratio of the curing accelerator, the amount thereof is preferably 0.05 to 7.0 weight parts, more preferably 0.2 to 4.0 weight parts, per 100 weight parts of the epoxy resin. Such ranges allow a satisfactory curing acceleration effect to be obtained and also can prevent discoloration satisfactorily from occurring.

The antioxidant is not particularly limited and can be a conventionally well-known antioxidant. Examples of the antioxidant include phenol compounds, amine compounds, organosulfur compounds, and phosphine compounds.

The modifier also is not particularly limited and can be a conventionally well-known modifier. Examples of the modifier include glycols, silicones, and alcohols.

Furthermore, a surfactant may be added to the epoxy resin. When an epoxy resin film is formed by a flow-expanding method while being in contact with air, the addition of the surfactant allows the film surface to be smoother. Examples of the surfactant include silicone, acrylic, and fluorochemical surfactants. A silicone surfactant is particularly preferable.

The method of producing the resin film is not particularly limited and the resin film can be produced by a conventionally well-know method. Examples of the method include a casting method, a flow-expanding method, an injection method, an extrusion molding method, and a roller coating method.

The resin film may be provided with, for instance, a gas barrier layer or a hard-coat layer to be formed thereon. The material and method to be employed for forming such a layer and the thickness thereof are not particularly limited. Preferable examples of the material of the gas barrier layer are poly(vinyl alcohol) and partially saponified poly(vinyl alcohol)s. Preferable examples of the material-of the hard-coat layer are three-dimensionally crosslinkable acrylic resins of a thermosetting type and a radiation curable type (for example, V, EB, etc.).

In the present invention, it is preferable that the polarizing plate film and the resin film be laminated together to form one body with, for instance, an adhesive or a pressure-sensitive adhesive. In this case, the adhesive or pressure-sensitive adhesive to be used herein is not particularly limited. Examples thereof include: adhesives or pressure-sensitive adhesives made of acrylic polymer, vinyl alcohol polymer, silicone polymer, polyester polymer, polyurethane polymer, polyether polymer, etc.; and rubber adhesives or pressure-sensitive adhesives. Furthermore, adhesives or pressure-sensitive adhesives including, for instance, a water-soluble crosslinking agent of vinyl alcohol polymer such as glutaraldehyde, melamine, oxalic acid, etc. also can be used. The above-mentioned adhesives or pressure-sensitive adhesives tend not to exfoliate even under the influence of humidity or heat and also are excellent in light transmittance and polarization degree. Among them, acrylic adhesives or pressure-sensitive adhesives are used most preferably in the view of their transparency and durability. The adhesive or pressure-sensitive adhesive may be of, for instance, a thermally crosslinkable type or a photo(ultraviolet rays or electron beams)crosslinkable type. The type thereof is not limited. Such adhesives and pressure-sensitive adhesives also can be employed for other uses. For example, they also can be used in laminating the laminated polarizing plate of the present invention and a surface protective sheet together.

The acrylic adhesive or pressure-sensitive adhesive may include transparent acrylic polymer as a base. The acrylic adhesive or pressure-sensitive adhesive may contain additives added suitably thereto or may have been complexified with, for instance, an inorganic filler, as required. The acrylic polymer contains, as its main component, at least one of acrylic alkyl ester and methacrylic alkyl ester. The acrylic polymer is obtained by adding a monomer for modification in order to improve the adhesiveness of the polarizing plate to the protective film and then polymerizing it by the usual method. The monomer for modification is one that can be copolymerized with the main component and has a polar group such as a hydroxyl group, a carboxyl group, an amino group, an amide group, a sulfonic group, a phosphate group, etc. The acrylic polymer may be crosslinked suitably for the purpose of adjusting its heat resistance as required.

The acrylic alkyl ester or methacrylic alkyl ester can be, for instance, linear or branched acrylic alkyl ester or methacrylic alkyl ester whose alkyl group has a carbon number of, for instance, 1 to 18, preferably 4 to 12. Examples of the acrylic alkyl ester or methacrylic alkyl ester include butyl acrylate, isobutyl acrylate, hexyl acrylate, 2-ethylhexyl acrylate, isooctyl acrylate, isononyl acrylate, allyl acrylate, lauryl acrylate, stearyl acrylate, butyl methacrylate, isobutyl methacrylate, hexyl methacrylate, 2-ethylhexyl methacrylate, isooctyl methacrylate, isononyl methacrylate, allyl methacrylate, lauryl methacrylate, stearyl methacrylate, etc. One of them may be used alone or two or more of them may be used together. In order to improve the adhesiveness of the adhesive or pressure-sensitive adhesive to the polarizing plate, the monomers with a polar group described below can be used additionally as monoethylene unsaturated monomers that can be copolymerized with the acrylic alkyl esters or methacrylic alkyl esters.

Examples of the monomers with a polar group include: carboxyl-group-containing monomers such as acrylic acid, methacrylic acid, carboxyethyl acrylate, carboxypentyl acrylate, itaconic acid, maleic acid, fumaric acid, crotonic acid, etc.; acid anhydride monomers such as maleic anhydride, itaconic anhydride, etc; sulfonic-group-containing monomers such as styrenesulfonic acid, allylsulfonic acid, 2-acrylamido-2-methylpropanesulfonic acid, 2-methacrylamido- 2-methylpropanesulfonic acid, acrylamidopropanesulfonic acid, methacrylamidopropanesulfonic acid, sulfopropyl acrylate, sulfopropyl methacrylate, acryloyloxynaphthalenesulfonic acid, methacryloyloxynaphthalenesulfonic acid, etc,; phosphate-group-containing monomers such as 2-hydroxyethylacryloyl phosphate, etc.; (N-substituted)amide monomers such as acrylamide, N,N-dimethyl acrylamide, N-butyl acrylamide, N-methylol acrylamide, N-methylolpropane acrylamide, methacrylamide, N,N-dimethyl methacrylamide, N-butyl methacrylamide, N-methylol methacrylamide, N-methylolpropane methacrylamide, etc.; alkylaminoalkyl monomers such as aminoethyl acrylate, N,N-dimethylaminoethyl acrylate, t-butylaminoethyl acrylate, aminoethyl methacrylate, N, N-dimethylaminoethyl methacrylate, t-butylaminoethyl methacrylate, etc.; alkoxyalkyl monomers such as methoxyethyl acrylate, ethoxyethyl acrylate, methoxyethyl methacrylate, ethoxyethyl methacrylate, etc.; succinimide monomers such as N-acryloyloxymethylenesuccinimide, N- acryloyl-6-oxyhexamethylenesuccinimide, N-acryloyl-8-oxyoctamethylenesuccinimide, N-methacryloyloxymethylenesuccinimide, N-methacryloyl-6-oxyhexamethylenesuccinimide, N-methacryloyl-8-oxyoctamethylenesuccinimide, etc.; vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, N-vinylcaprolactam, etc.; cyano acrylate monomers such as acrylonitrile, methacrylonitrile, etc.; epoxy-group-containing acrylic monomers such as glycidyl acrylate, glycidyl methacrylate, etc.; glycol acryl ester monomers such as polyethylene glycol acrylate, polypropylene glycol acrylate, methoxyethylene glycol acrylate, methoxypolypropylene glycol acrylate, polyethylene glycol methacrylate, polypropylene glycol methacrylate, methoxyethylene glycol methacrylate, methoxypolypropylene glycol methacrylate, etc.; and acrylic ester monomers such as tetrahydrofurfuryl acrylate, fluorine acrylate, silicone acrylate, tetrahydrofurfuryl methacrylate, fluorine methacrylate, silicone methacrylate, 2-methoxyethyl acrylate, etc.

When the acrylic alkyl ester or methacrylic alkyl ester and a monoethylene unsaturated monomer are copolymerized, the blending ratio of the acrylic alkyl ester or methacrylic alkyl ester to be a main component is in the range of, for instance, 60 wt. % to 95 wt. %, preferably 80 wt. % to 95 wt. %, while the blending ratio of the monoethylene unsaturated monomer may be determined suitably so as to allow the total amount of the acrylic alkyl ester or methacrylic alkyl ester and the monoethylene unsaturated monomer to be 100 wt. % and therefore may be set in the range of, for instance, 40 wt. % to 5 wt. %, preferably 20 wt. % to 5 wt. %. When the acrylic alkyl ester or methacrylic alkyl ester and the monoethylene unsaturated monomer are used within such ranges, an adhesive that can prevent cracking from occurring can be obtained that is excellent in adhesiveness to the polarizing plate as well as impact-force relaxing characteristics.

The acrylic polymer can be prepared using a conventionally well-known method. For instance, a mixture of the main component described above and monomers of two or more of polar-group-containing monomer components can be prepared by a solution polymerization method, an emulsion polymerization method, a bulk polymerization method, a suspension polymerization method, etc. In that case, a polymerization initiator may be used as required. Examples of the polymerization initiator include a thermal polymerization initiator, a photopolymerization initiator, etc.

Examples of the thermal polymerization initiator include: organic peroxides such as benzoyl peroxide, t-butyl perbenzoate, cumene hydroperoxide, diisopropyl peroxydicarbonate, di-n-propyl peroxydicarbonate, di(2-ethoxyethyl) peroxydicarbonate, t-butyl peroxyneodecanoate, t-butyl peroxypivalate, (3,5,5-trimethylhexanoyl) peroxide, dipropionyl peroxide, diacetyl peroxide, etc.; and azo compounds such as 2,2′-azobisisobutyronitrile, 2,2′-azobis(2-methylbutyronitrile), 1,1′-azobis(cyclohexane 1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), 2,2′-azobis [2-(2-imidazoline-2-yl)propane], etc.

Examples of the photopolymerization initiator include: acetophenone compounds such as 4-(2-hydroxyethoxy)phenyl(2-hydroxy-2-propyl) ketone, a-hydroxy- α,α′-dimethylacetophenone, methoxyacetophenone, 2,2-dimethoxy-2-phenylacetophenone, 2,2-diethoxyacetophenone, 1-hydroxycyclohexyl phenyl ketone, 2-methyl-1-[4-(methylthio)-phenyl]-2-morpholinopropane-1, etc.; benzoin ether compounds such as benzoin ethyl ether, benzoin isopropyl ether, anizoin methyl ether, etc.; α-ketol compounds such as 2-methyl-2-hydroxypropiophenone, etc.; ketal compounds such as benzyldimethylketal, etc.; aromatic sulfonyl chloride compounds such as 2-naphthalenesulfonyl chloride, etc.; photoactive oxime compounds such as 1-phenone-1,1-propanedione-2-(o-ethoxycarbonyl)oxime, etc.; and benzophenone compounds such as benzophenone, benzoyl benzoate, 3,3′-dimethyl-4-methoxybenzophenone, etc.

The amount of the polymerization initiator to be used is in the range of, for instance, 0.005 to 5 weight parts per 100 weight parts of monomers and can be determined suitably according to the type thereof. When the photopolymerization initiator is used, the amount thereof is preferably in the range of, for instance, 0.005 to 1 weight part, and particularly preferably in the range of 0.05 to 0.5 weight part. When the amount of the photopolymerization initiator is in such ranges, an adhesive or pressure-sensitive adhesive to be obtained thereby is excellent in reactivity between monomers and the photopolymerization initiator, adhesiveness between the adhesive layer and the polarizing plate film or resin film, and hue. When the thermal polymerization initiator is to be used, the amount thereof is in the range of, for instance, 0.01 to 5 weight parts, and particularly preferably in the range of 0.05 to 3 weight parts for the same reason as described above.

In causing the polymerization reaction, polyfunctional acrylate or methacrylate having two or more of acryloyl groups or methacryloyl groups in molecules thereof may be added as a crosslinking agent (an internal crosslinking agent) together with the above-mentioned polymerization initiator as required, and thereby may improve, for instance, cohesion of an impact-force relaxing member to increase shear strength. Examples of such polyfunctional acrylate or methacrylate include: hexanediol diacrylate, ethylene glycol diacrylate, (poly)propylene glycol diacrylate, neopentyl glycol diacrylate, pentaerythritol diacrylate, trimethylolpropane triacrylate, pentaerythritol triacrylate, dipentaerythritol hexaacrylate, epoxy acrylate, polyester acrylate, urethane acrylate, hexanediol dimethacrylate, (poly)ethylene glycol dimethacrylate, (poly)propylene glycol dimethacrylate, neopentyl glycol dimethacrylate, pentaerythritol dimethacrylate, trimethylolpropane trimethacrylate, pentaerythritol trimethacrylate, dipentaerythritol hexamethacrylate, etc.

The amount of the polyfunctional acrylate or methacrylate to be used is in the range of, for instance, 0.01 to 10 weight parts, preferably 0.05 to 5 weight parts, per 100 weight parts of monomers. In the case of bifunctional acrylate or methacrylate, it is preferable that a slightly larger amount thereof be used. On the other hand, in the case of trifunctional or more functional acrylate or methacrylate, it is preferable that a slightly less amount thereof be used. When such ranges are employed, a high crosslinking degree is exhibited after photopolymerization, and excellent adhesiveness between the adhesive layer and the polarizing plate film or the resin film is obtained.

The polymerization reaction can be caused by, for instance, a photopolymerization method using ultraviolet rays, etc. or a thermal polymerization method according to the type of the polymerization initiator. The photopolymerization method is particularly preferable from the viewpoint of processability of the adhesive or pressure-sensitive adhesive in forming it into a pressure-sensitive adhesive sheet, adhesive properties, etc. Preferably, the photopolymerization method is carried out, for instance, in an atmosphere that has been substituted with an inert gas such as a nitrogen gas and that contains no oxygen, or in the state where the adhesive or pressure-sensitive adhesive is isolated from air by being covered with an ultraviolet-rays transmitting film.

In the photopolymerization method, ultraviolet rays to be used are electromagnetic radiation having a wavelength in the range of around 180 nm to 460 nm, but electromagnetic radiation with a longer or shorter wavelength than that also may be used. The ultraviolet source to be used herein can be an irradiation device such as, for instance, a mercury arc, a carbon arc, a low-pressure mercury lamp, an intermediate-/high-pressure mercury lamp, a metal halide lamp, a chemical lamp, or a black-light lamp. The intensity of ultraviolet rays can be set suitably through adjustments of voltage or the distance to an object to be irradiated therewith. Generally, it is preferable that the integrated optical power be in the range of 0.5 to 10 J/cm² with consideration given to irradiation time (productivity). Furthermore, when the coating thickness of the adhesive is at least 0.2 mm, the adhesive may swell due to the heat generated when being polymerized and thereby may lose smoothness. However, when being cooled during the photopolymerization, the adhesive can be prevented from swelling.

Furthermore, one or more of plasticizers with excellent transparency may be blended into the adhesive or pressure-sensitive adhesive as required. The amount thereof to be blended is, for instance, 5 to 300 weight parts, preferably 10 to 200 weight parts, per 100 weight parts of the monomers (or polymers thereof).

Examples of such plasticizers include: phthalic acid compounds such as dimethyl phthalate, diethyl phthalate, dibutyl phthalate, diheptyl phthalate, di-2-ethylhexyl phthalate, diusononyl phthalate, diisodecyl phthalate, dibutylbenzyl phthalate, dioctyl phthalate, butylphthalylbutyl glycolate, etc.; adipic acid compounds such as diusobutyl adipate, diusononyl adipate, diisodecyl adipate, dibutoxyethyl adipate, etc.; sebacic acid compounds such as dibutyl sebacate, di-2-ethylhexyl sebacate, etc.; phosphoric acid compounds such as triethylene phosphate, triphenyl phosphate, tricresyl phosphate, trixylenyl phosphate, cresylphenyl phosphate, etc.; fatty acid compounds such as dioctyl sebacate, methyl acetyl ricinolate, etc; epoxy compounds such as diisodecyl-4,5-epoxytetrahydro phthalate, etc.; trimellitic acid compounds such as tributyl trimellitate, tri-2-ethylhexyl trimellitate, tri-n-octyl trimellitate, triusodecyl trimellitate, etc.; butyl oleate; chlorinated paraffin; polypropylene glycol; polytetramethylene glycol; and polyoxyalkylene glycol such as polybutene, polyisobutylene, etc.

In addition, various additives may be blended into the adhesive or pressure-sensitive adhesive to the extent that does not impair its transparency, as required. The various additives include a colorant such as, for instance, a dye or pigment having a property of absorbing near infrared rays (800 nm to 1100 nm) or neon light (570 nm to 590 nm), a tackifier, an antioxidant, an age resistor, an ultraviolet absorber, a silane coupling agent, a natural product, synthetic resins, acrylic oligomer, glass fibers, glass beads, etc. Furthermore, the adhesive may contain fine particles to exhibit light diffusibility.

In the manufacturing method of the present invention, it is preferable that the surface protective sheet be, for instance, a sheet containing resin that is excellent in mechanical strength and heat resistance. Examples of the resin include: polyester polymers such as polyethyleneterephthalate, polyethylenenaphthalate, etc.; cellulose polymers such as diacetyl cellulose, triacetyl cellulose, etc.; acrylic polymers such as polymethyl acrylate, polymethyl methacrylate, etc.; styrene polymers such as polystyrene, acrylonitrile-styrene copolymer (AS resin), etc.; and polycarbonate polymers. Further examples of the resin include: polyolefin polymers such as polyethylene, polypropylene, polyolefin having a cyclo or norbornene structure, ethylene-propylene copolymer, etc.; vinyl chloride polymers; nylon and aromatic polyamide polymers; imide polymers; sulfone polymers; polyethersulfone polymers; polyetherether ketone polymers; vinylidene chloride polymers; vinyl alcohol polymers; vinyl butyral polymers; allylate polymers; polyoxymethylene polymers; epoxy polymers; and blends of the above-mentioned polymers. Among them, polyester polymers such as polyethyleneterephthalate, polyethylenenaphthalate, etc. are preferable.

With respect to swellings and projections produced on cutting planes of the laminated polarizing plate of the present invention, the size of swellings and the length of projections are preferably 10 μm or smaller and 50 μm or shorter, more preferably 5 μm or smaller and 30 μm or shorter, respectively, and most preferably both swellings and projections are not present (smaller than measuring limit). The size of swellings and the length of projections can be measured by the methods described later in the examples, for instance.

Next, the image display of the present invention is described. The image display of the present invention includes an image display element and a laminated polarizing plate of the present invention that is disposed at a certain distance from the image display element. Preferably, nothing, i.e. a gap, exists between the image display element and the laminated polarizing plate. A liquid crystal cell is preferable as the image display element. The present invention, however, is not limited to this. The image display of the present invention also can be used for self-light-emitting displays such as, for example, an organic electroluminescence (EL) display, a plasma display panel (PDP), and a field emission display (FED). In addition, examples of the liquid crystal display include those used for viewfinders of video cameras and digital cameras, those used for projectors, etc.

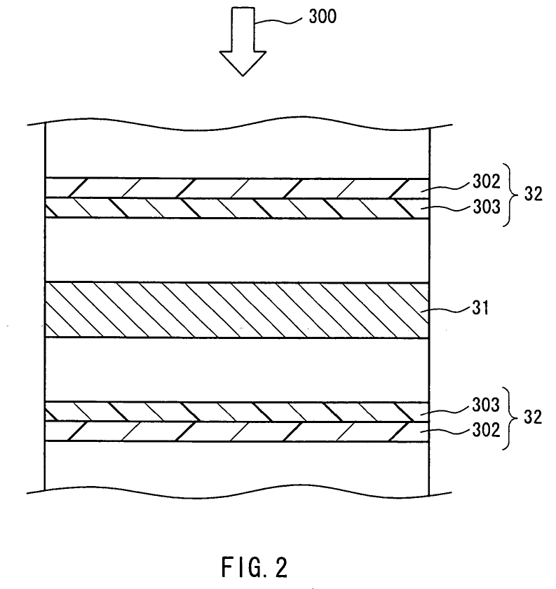

FIG. 2 shows a cross-sectional view of an example of the liquid crystal display of the present invention. As shown in FIG. 2, this display includes a liquid crystal cell 31 and laminated polarizing plates 32 of the present invention, with the liquid crystal cell 31 and the laminated polarizing plates 32 being spaced out. The laminated polarizing plates 32 each are formed of a polarizing plate 303 and a resin film 302 that are laminated together. The arrow 300 shown in FIG. 2 indicates a viewing direction.

The type of the liquid crystal cell of the liquid crystal display can be selected suitably. Various types of liquid crystal cells can be used including, for instance, those of an active-matrix driving type that is typified by a thin film transistor type and those of simple-matrix driving type that is typified by a twisted nematic (TN) type and a super-twisted nematic (STN) type. The laminated polarizing plate of the present invention preferably is used in combination particularly with a TN cell, a vertical alignment (VA) cell, an optically aligned birefringence (OCB) cell, or an in plane switching (IPS) cell.

Generally, the liquid crystal cell has a configuration in which the gap between a pair of opposed liquid crystal cell substrates is filled with liquid crystal. The liquid crystal cell substrates are not particularly limited. For instance, glass substrates or plastic substrates can be used. The materials of the plastic substrates also are not particularly limited and conventionally well-known materials can be used.

The present invention is described below further in detail using examples and comparative examples. The present invention, however, is not limited to the following examples. The characteristics of laminated polarizing plates were evaluated by the following methods.

### EXAMPLE

(1) Measurement of Size of Swelling of Cutting Plane

With respect to a laminated polarizing plate with a size of 10 mm×11 mm, the thickness of its central part and that of its part near a cutting plane were measured with a micrometer and then the difference between them was determined as the size of a swelling.

(2) Measurement of Projections of Cutting Plane

The length of projections produced on cutting planes (indicated with a and b in FIG. 1) of a laminated polarizing plate was observed and measured from the upper side thereof using a laser microscope or an optical microscope.

(3) Determination of Surface Contamination

The surfaces of a laminated polarizing plate located on the polarizing plate side and the resin film side were observed visually and were evaluated. A surface with stains was indicated with “x” while a surface with no stains was indicated with “∘”.

### Example 1

Production of Polarizing Plate Film

First, a poly(vinyl alcohol) film (with a thickness of 80 μm) was stretched in an iodine aqueous solution so as to become five times larger, which then was dried. Thus, a polarizer was produced. Subsequently, a UV urethane hard-coat layer with a reflectance of 1% or less and a physical-optical thin film (an AR layer) were formed sequentially on one surface of a triacetylcellulose film (a TAC film). Thereafter, the TAC film thus treated and an untreated TAC film were laminated on a surface of the polarizer and the other surface of the polarizer with an adhesive used therebetween, respectively. Thus, a polarizing plate film (with a thickness of 195 μm and a light transmittance of 45%) was produced.

Production of Resin Film

First, 120 weight parts of methyltetrahydrophthalic anhydride used as a curing agent and 2 weight parts of tetra-n-butylphosphoniumO,O-diethyl phosphorodithioate used as a curing accelerator were added to 100 weight parts of 3,4-epoxycyclohexylmethyl-3,4-epoxycyclohexanecarboxylate. This was stirred to be mixed together and then was formed into a prefilm using the flow-expanding method. Further, the prefilm was thermally cured at 180° C. for 30 minutes. Thus, an epoxy film (with a thickness of 700 μm and a size of 380 mm×280 mm) was produced. Subsequently, one surface of the epoxy film was coated with an acryl urethane UV resin to be provided with a protective layer (with a thickness of 3 μm) thus formed. Thus, a resin film was obtained. This resin film had a light transmittance of 91.7% and a glass-transition temperature of 180° C.

Production of Pressure-Sensitive Adhesive

First, 100 weight parts of butyl acrylate, 5.0 weight parts of acrylic acid, 0.075 weight part of 2-hydroxyethyl acrylate, 0.3 weight part of azobisisonitrile, and 250 weight parts of ethyl acetate were mixed together. This was allowed to react at about 60° C. for six hours while being stirred. Thus an acrylic polymer solution having a weight-average molecular weight of 1630000 was obtained. Thereafter, with respect to 100 weight parts of polymer solid content of the solution, 0.6 weight part of isocyanate polyfunctional compound (Product Name: COLONATE L, manufactured by NIPPON POLYURETHANE INDUSTRY CO. LTD.) and 0.08 weight part of silane coupling agent (Product Name: KBM403, manufactured by SHIN-ETSU CHEMICAL CO. LTD.) were added to the acrylic polymer solution. Thus, a pressure-sensitive adhesive solution was prepared. The pressure-sensitive adhesive solution thus obtained had a peel strength at 90° peeling of 10 N/25 mm.

Production of Surface Protective Sheet

The pressure-sensitive adhesive was applied onto a PET film (with a thickness of 50 μm) to have a thickness of 10 μm and then was dried. Thus a surface protective sheet was obtained.

Production of Laminate

The untreated TAC film side of the polarizing plate was attached to the epoxy film side of the resin film, with the pressure-sensitive adhesive (with a thickness of 23 μm) being interposed therebetween. The surface protective sheet was attached to each surface of this laminate with the pressure-sensitive adhesive.

Cutting Method

A dicing tape (with a thickness of 170 μm, Product Name: ELEPHOLDER NBD5170K, manufactured by Nitto Denko Corporation) was attached to the treated TAC film side of the polarizing plate of the laminate. The laminate was attached to a fixture for dicing, with the side of the laminate to which the dicing tape had been attached being in contact with the fixture.

Subsequently, using a dicer (DAD341 Dicer, manufactured by Disco Corporation) and a grinder (a blade with a thickness of 0.15 mm; Product Name: Z1100LS3 #600, manufactured by Disco Corporation), the laminate was cut under the conditions of a rotating speed of 20000 rpm and a cutting speed of 10 mm/sec. The dicing tape located under the laminate was cut in to a depth of 100 μm of the 170-μm thicknesses. Thus about 110 laminated polarizing plates with a size of 10 mm×11 mm were produced from a laminate with a size of 150 mm×150 mm.

Method of Washing and UV Irradiation

The laminated polarizing plates that had been cut on the dicing tape were washed with a spinner (DCS140, manufactured by Disco Corporation). This was irradiated with black light from the dicing tape side for two minutes and thereby the adhesiveness between the laminated polarizing plates and the dicing tape decreased. Eventually, the laminated polarizing plates were separated from the dicing tape.

### Example 2

Laminated polarizing plates were produced in the same manner as in Example 1 except that a laminate was cut under the conditions of a rotating speed of 50000 rpm and a cutting speed of 100 mm/sec using a dicer (DFD651 Dicer, manufactured by Disco Corporation) and a grinder (a blade with a thickness of 200 μm; Product Name: Z1110LS3 #400, manufactured by Disco Corporation).

### Example 3

Laminated polarizing plates were produced in the same manner as in Example 1 except that the resin film used herein had a thickness of 300 μm and a laminate was cut by cuttings carried out twice on the same line under the conditions of a rotating speed of 50000 rpm and a cutting speed of 150 mm/sec using a dicer (DFD651 Dicer, manufactured by Disco Corporation) and a grinder (a blade with a thickness of 200 μm; Product Name: Z1110LS3 #400, manufactured by Disco Corporation). In the cuttings carried out twice on the same line, both the first-cutting depth and the second-cutting depth were the same, specifically the dicing tape was cut in to a depth of 50 μm. The cutting order was: X-axis direction→Y-axis direction→X-axis direction→Y-axis direction. The X-axis direction denotes the polarization axis or absorption axis while the Y-axis direction indicates a direction perpendicular to the X-axis direction.

### Example 4

Laminated polarizing plates were produced in the same manner as in Example 1 except that a commercially available acrylic plate (with a thickness of 1 mm; Product Name: ACRYLITE, manufactured by MITSUBISHI RAYON CO., LTD.) was used as the resin film. The commercially available acrylic plate had a light transmittance of 93% and a glass-transition temperature of 105° C.

### Comparative Example 1

Laminated polarizing plates were produced in the same manner as in Example 1 except that a PET film (with a thickness of 38 μm) (Product Name: T-600, manufactured by MITSUBISHI CHEMICAL CORPORATION) was used instead of the epoxy resin film. The PET film had a light transmittance of 92% and a glass-transition temperature of 90° C.

### Comparative Example 2

Laminated polarizing plates were produced in the same manner as in Example 1 except that the laminate was cut using a CO₂ laser (Product Name: LC-100A, manufactured by Roland DG Corporation) instead of the dicer. The laminate was cut at 25 W and a cutting speed of 60 mm/sec by being subjected to laser irradiation twice.

With respect to the laminated polarizing plates obtained in Examples 1 to 4 and Comparative Examples 1 and 2, the size of swellings and the length of projections produced on end faces (cutting planes) thereof were measured. The results are indicated in Table 1 below. As indicated in Table 1, the size of swellings produced at cutting planes and the length of projections produced on the cutting planes were reduced in Examples 1 to 4 as compared to Comparative Examples 1 and 2. In all the examples, no surface contamination was observed, but surface contamination occurred in Comparative Example 2 where the laser cutting was employed.

TABLE 1

| | Swelling of | Length of | |
|---|---|---|---|
| | Cutting Plane | Projections | Surface |
| | (μm) | (μm) | Contamination |
| Example 1 | <5 | 10 | ∘ |
| Example 2 | <5 | 25 | ∘ |
| Example 3 | <5 | 20 | ∘ |
| Example 4 | <5 | 30 | ∘ |
| Comparative | 10 | 100 | ∘ |
| Example 1 | | | |
| Comparative | 35 | 70 | x |
| Example 2 | | | |

According to the manufacturing method of the present invention, the production of swellings of cutting planes and projections on the cutting planes can be controlled, and self-standing laminated polarizing plates with sufficiently high rigidity can be obtained. The laminated polarizing plates obtained by the manufacturing method of the present invention are applicable to various types of image displays. Particularly, they can be used preferably for liquid crystal displays for viewfinders of video cameras and digital cameras and liquid crystal displays for projectors.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A method of manufacturing a laminated polarizing plate, comprising laminating a polarizing plate film and a resin film together to form a lamination film, and cutting the lamination film with a dicer to divide it into laminated polarizing plates,
wherein the resin film has a light transmittance of at least 80% and a glass-transition temperature of at least 100° C.

2. The method of manufacturing a laminated polarizing plate according to claim 1, wherein the resin film comprises at least one selected from the group consisting of an epoxy resin, a polyimide resin, a polyester resin, an acrylic resin, a methacrylic resin, a polycarbonate (PC) resin, a polyethylenenaphthalate (PEN) resin, a polyethyleneterephthalate (PET) resin, a triacetylcellulose (TAC) resin, a norbornene resin, a polyetherimide resin, a polyamide resin, a polysulfone resin, a polyphenylene sulfide resin, and a polyethersulfone resin.

3. The method of manufacturing a laminated polarizing plate according to claim 1, wherein the resin film is at least one of an epoxy resin film and an acrylic resin film.

4. The method of manufacturing a laminated polarizing plate according to claim 1, wherein the resin film has a retardation of 5 nm or less.

5. The method of manufacturing a laminated polarizing plate according to claim 1, wherein the light transmittance is in a range of 80% to 100%.

6. The method of manufacturing a laminated polarizing plate according to claim 1, wherein the glass-transition temperature is in a range of 100° C. to 400° C.

7. The method of manufacturing a laminated polarizing plate according to claim 1, wherein the resin film has a thickness in a range of 0.05 mm to 1.5 mm.

8. The method of manufacturing a laminated polarizing plate according to claim 1, wherein in the process of cutting the lamination film with a dicer, the lamination film is cut in at least one direction of a polarization axis direction and an absorption axis direction in the polarizing plate film.

9. The method of manufacturing a laminated polarizing plate according to claim 1, wherein in the process of cutting the lamination film with a dicer, the lamination film is cut under at least one condition selected from the group consisting of a dicing blade thickness of 30 μm to 1000 μm, a dicing blade grit size of #200 to #1000, a dicing blade rotating speed of 10000 rpm to 60000 rpm, and a dicing speed of 10 mm/sec to 300 mm/sec.

10. The method of manufacturing a laminated polarizing plate according to claim 1, wherein in the process of cutting the lamination film with a dicer, the lamination film is attached to the dicer with a pressure-sensitive adhesive sheet and then the lamination film is cut in this state.

11. The method of manufacturing a laminated polarizing plate according to claim 1, wherein in the process of cutting the lamination film with a dicer, the lamination is cut so that the laminated polarizing plate has a shape and size that are suitable for an image display in which it is to be used.

12. The method of manufacturing a laminated polarizing plate according to claim 11, wherein the image display is a liquid crystal display for a viewfinder or a liquid crystal display for a projector.

13. A laminated polarizing plate, comprising a polarizing plate and a resin film that are laminated together, wherein the laminated polarizing plate is manufactured by the method according to claim 1.

14. The laminated polarizing plate according to claim 13, wherein the laminated polarizing plate has a cutting plane with a swelling of 10 μm or smaller.

15. The laminated polarizing plate according to claim 13, wherein the laminated polarizing plate has a cutting plane with projections having a length of 50 μm or less.

16. The laminated polarizing plate according to claim 13, wherein the laminated polarizing plate is used for a liquid crystal display for a viewfinder or a liquid crystal display for a projector.

17. An image display, comprising an image display element and a polarizing plate, wherein the polarizing plate is a laminated polarizing plate according to claim 13, and the laminated polarizing plate is disposed at a certain distance from the image display element.

18. The image display according to claim 17, wherein a gap exists between the image display element and the polarizing plate.

19. The image display according to claim 17, wherein the image display element is a liquid crystal cell.

20. The image display according to claim 19, wherein the image display is used for a viewfinder or a projector.

21. The image display according to claim 20, wherein the viewfinder is used for a video camera or a digital camera.
